(19) United States
(12) Patent Application Publication
(10) Pub. No.: US 2018/0010954 A1
(43) Pub. Date: Jan. 11, 2018

(54) MATERIAL HANDLING SYSTEM

(71) Applicant: Dublin Lowndes, LLC, Johns Island, SC (US)

(72) Inventors: Rawlins Lowndes, Johns Island, SC (US); Andre Dublin, Johns Island, SC (US)

(73) Assignee: Dublin Lowndes, LLC, Johns Island, SC (US)

(21) Appl. No.: 15/646,140

(22) Filed: Jul. 11, 2017

Related U.S. Application Data
(60) Provisional application No. 62/360,624, filed on Jul. 11, 2016.

(51) Int. Cl. G01G 19/12; G06F 7/02; G06F 13/14; G01G 19/08; H04L 12/40

(52) U.S. Cl. CPC G01G 19/12; G06F 13/14; G01G 19/083; G06F 7/02; H04L 2012/40273

(57) ABSTRACT

A material handling system, associated with the delivery of one or more payloads, may include a material handling vehicle configured to haul a payload from a first location to a second location. The material handling vehicle may include a sensor to obtain information associated with a payload, of the one or more payloads, and a vehicle device configured to receive a signal from the sensor to obtain information associated with the payload and to communicate with a server device, via a network, to send the information associated with the payload and to send and/or receive information associated with a material handling project. The material handling vehicle may further include a vehicle identifier to uniquely identify the material handling vehicle.

### REFERENCE TO RELATED APPLICATION

This application claims priority to U.S. Provisional Patent Application No. 62/360,624 filed on Jul. 11, 2016, the entire contents of the provisional application being incorporated herein by reference.

### BACKGROUND

Many industries have the need to haul a payload (e.g. asphalt, concrete, fill dirt, rock, sand, muck, topsoil, grain, gasoline, etc.) of one type or another from one location to another location using a material handling vehicle (e.g. dump trucks, tractor trailers, cement mixers, flatbeds, pickup trucks, tankers, vans etc.). There is no present way to confirm that the payload hauled on the material handling vehicle is acceptable until the payload arrives at its destination because the payload cannot be inspected by the user of the materials (e.g. general contractor, developer, etc.) until it arrives at its destination. At that point, if the material is not acceptable, the costs associated with hauling the material have been incurred, and acquiring an acceptable substitute requires the user to send back the original payload and await the delivery of the substitute, which results in additional time and expense.

Material handling vehicle drivers are typically hired through a material handling company that assigns the drivers to a job and bills the hiring person (e.g. developer, general contractor, or other person and/or entity in charge of hiring the material handling vehicle), based upon an hourly rate for the driver, by the number of loads, and/or the number of trips made by driver. If the driver is paid hourly, there is no present way to ensure that material handling vehicle drivers are actively working the job for which they are paid (i.e. using the best route, not making prolonged stops, resting, avoiding traffic, etc.). If the material handling vehicle is paid by the trip or number of trips made, then there is no way to verify that the driver has actually made the requested number of trips and/or hauled the material (type and/or quantity) for which the general contractor is billed, other than traditional methods requiring employees and a paper trail. Further, the payload not generally inspected by the hiring party until the payload arrives at its destination. At that point, the expense of hiring the material handling vehicle has been incurred.

Traditionally, to verify that material handling vehicle drivers are making the number of trips billed to the general contractor and hauling the correct amounts and types of material, many general contractors hire an employee to count the number of times each material handling vehicle has arrived at a destination with a payload. The employee records the number of trips, the amount of payload delivered, and associated information, on a document which is used to confirm the amount owed for the material handling services. This traditional method is expensive because as it requires paying for an employee, and is subject to human error. Further, this traditional method does not ensure that the material handling vehicle's driver is not delivering the cargo to an alternative destination (e.g. to sell to another) while the material handling vehicle and/or the cargo are being paid by a hiring company.

Hiring a material handling vehicle typically requires the requestor to first request the services from a material handling company and then wait for a material handling vehicle to be available. If the material handling company does not presently have any material handling vehicles available for use, the requestor must wait until a material handling vehicle is available, although other material handling vehicles, not associated with that material handling company, may be available.

### SUMMARY

According to one implementation, described herein, a material handling vehicle, configured to haul a payload from a first location to a second location, may include a sensor that may obtain information associated with the payload. The material handling vehicle may further include a vehicle device which may communicate with the sensor to receive a signal that includes the information associated with the payload. The vehicle device may additionally, or alternatively, communicate with a server device, via a network, to send the information associated with the payload. The vehicle device may further communicate with the server device, via the network, to send or receive information associated with a material handling project. The material handling vehicle may further include a vehicle identifier to uniquely identify the material handling vehicle. The sensor of the material handling vehicle may be one of the following: an electro-optical sensor, a camera, a video recorder, a radio frequency (RF) sensor, an ultrasonic sensor, a thermocouple, a laser, a proximity sensor, an acoustic sensor, a chemical sensor, a mechanical sensor, an electro-mechanical sensor, a potentiometer, a geiger counter, a pH sensor, or a gypsum resistance block. The information associated with the payload may include temperature, presence, pressure, granularity, humidity, moisture content, weight, mass, density, volume, pH, organic content, texture, radioactivity, video, or a picture. The information associated with the material handling project may include a type of payload to be delivered, an amount of payload to be delivered, an acceptable value for the information associated with the payload, an address of the first location, an address of the second location, a location of the material handling vehicle, availability of the material handling vehicle, identification of the material handling vehicle, a route of travel associated with the material handling vehicle, a speed of the material handling vehicle, an average speed of the material handling vehicle, a direction of travel of the material handling vehicle, a number of trips associated with the material handling vehicle, a date and time when the material handling vehicle arrived at the first location, a date and time when the material handling vehicle arrived at the second location, an estimated date and time when the material handling vehicle will arrive at the first location or the second location, an amount of fuel being used by the material handling vehicle, an amount of fuel that has been used by the material handling vehicle, an identification of a project for which a payload is being hauled, a schedule for the material handling vehicle, weather conditions, traffic conditions, road conditions, rate information associated with the material handling vehicle, or cost information associated with a payload, a material handling vehicle or a material handling project. The material handling vehicle may execute instructions to compute information associated with a material handling project or information associated with the payload using the signal obtained from the sensor. The vehicle device may be permanently installed in the material handling vehicle or may be removably installed in the material handling vehicle. The vehicle identifier may be mounted to the vehicle or may be located on the vehicle device. The vehicle device may communicate with the sensor via a wired and/or wireless connection between the vehicle device and the sensor.

According to another implementation, described herein, a material handling system, associated with the delivery of one or more payloads, may include a material handling vehicle configured to haul a payload from a first location to a second location. The material handling vehicle may include a sensor to obtain information associated with a payload, of the one or more payloads and may include a vehicle device. The vehicle device may be configured to receive a signal from the sensor to obtain information associated with the payload, and to communicate with a first server device, via a network, to send the information associated with the payload and to send and/or receive information associated with a material handling project. The material handling vehicle may further include a vehicle identifier to uniquely identify the material handling vehicle. The first server device configured to communicate with the vehicle device to send and/or receive information associated with a material handling project and to receive information associated with the payload. The material handling system may further include a scanner configured to interrogate the vehicle identifier to authenticate the material handling vehicle. The scanner may be a server device. The material handling system may further include a second server device configured to send information associated with a material handling project to the first server device or to receive information associated with a material handling project from the first server device. The first server device may be associated with the first location, the second location, or a requestor of the payload.

According to another implementation, described herein, a method for delivering a payload from a first location to a second location via a material handling vehicle may include receiving, by a vehicle device and from a server device, a request via a network for a payload to be delivered to a second location. The vehicle device being associated with a material handling vehicle. The method may further include accepting, by a vehicle device via the network, the request from the server device. The method may further include obtaining, by the material handling vehicle, the payload from the first location. The method may further include obtaining, by a sensor associated with the material handling vehicle, information associated with the payload. The method may further include providing, by the sensor to the vehicle device via a wired or wireless connection, the information associated with the payload. The method may further include providing, by the vehicle device via the network, to the server device the information associated with the payload. The method may further include delivering, by the material handling vehicle, the payload to the second location. The method may further include providing, by the vehicle device via the network, to the service device confirmation that the payload has been delivered to the second location. The method may further include scanning, by a scanner associated with the first location or the second location, a vehicle identifier associated with the material handling vehicle. The method may further include providing, by a second server device associated with the scanner, the identification of the material handling vehicle to the first server device. The method may further include that the scanner may be the second server device or that the vehicle identifier is located on the vehicle device.

### BRIEF DESCRIPTION OF THE DRAWINGS

FIG. 1 illustrates an example environment in which the Systems and/or Methods described herein may be implemented.

FIG. 2 illustrates a schematic view of a server of FIG. 1.

FIG. 3 illustrates a schematic view of a vehicle device of FIG. 1.

FIG. 4 illustrates an example environment in which the Systems and/or Methods described herein may be implemented.

### DETAILED DESCRIPTION

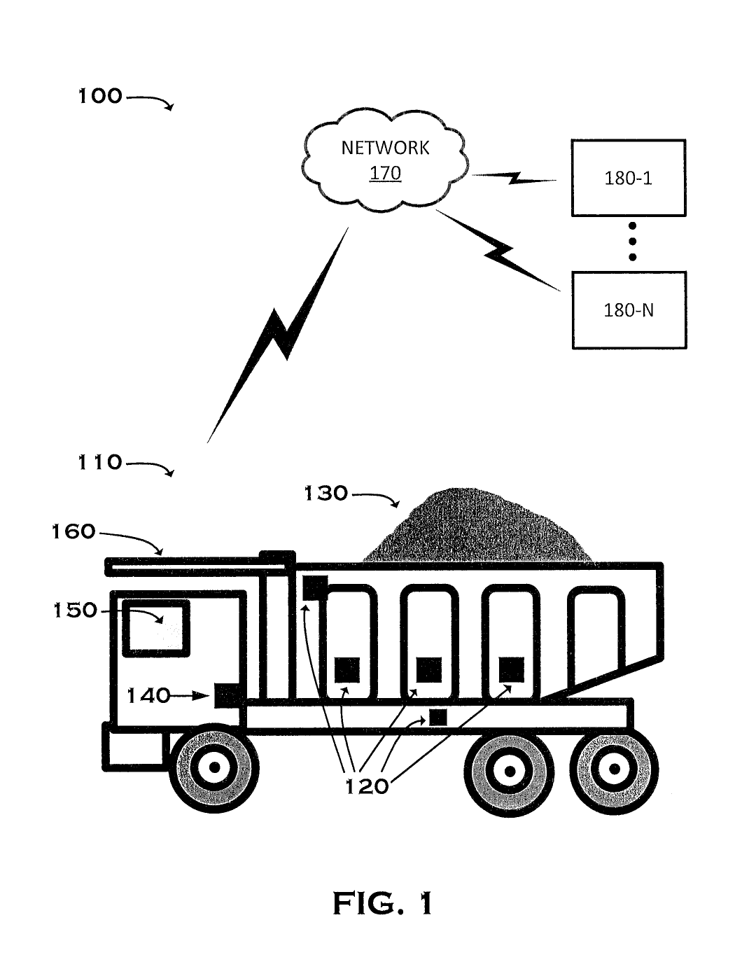

FIGS. 1-4 are attached hereto and incorporated herein by reference. The following detailed description refers to the accompanying FIGS. 1-4. The same reference numbers in different figures may identify the same or similar elements.

The systems, methods, technologies and/or techniques (hereinafter “systems and/or methods”), as described herein, may include a material handling vehicle system that may include a material handling vehicle (e.g., a dump truck, cement mixing truck, flatbed truck, tractor trailor, tankers, vans etc.) that includes one or more sensors (e.g., electro-optical (in the infrared, ultra-violet and/or visual spectrum), radio frequency (RF), laser, temperature, weight, fill level, moisture, etc. sensors), a vehicle device, a vehicle identifier associated with the vehicle (e.g. radio frequency transponders, barcodes, etc.), one or more server devices, and/or a scanner. The vehicle device may communicate with the one or more and sensors and/or may communicate with one or more server devices and/or with other vehicle devices via a network.

The material handling vehicle may be a dump truck, cement mixing truck, flatbed truck, tractor trailer, a liquid tanker truck, low boy truck, and/or any other vehicle that may carry a payload. The material handling vehicle may include one or more sensors, the vehicle device and/or a vehicle identifier.

The one or more sensors may include any type of sensor capable of obtaining information associated with a payload, including electro-optical sensors (in the infrared, ultra-violet and/or visual spectrum), cameras, video recorders, radio frequency (RF) sensors, ultrasonic sensors, lasers, thermocouples, proximity sensors, acoustic sensors, chemical sensors, mechanical sensors, electro-mechanical sensors, litmus, potentiometer, geiger counter, gypsum resistance block, etc. The information associated with the payload may include temperature, pressure, granularity, humidity, moisture content, weight, mass, density, volume, pH, organic content, texture, radioactivity, and any other information that may demonstrate a quality or characteristic of the payload. The information associated with the payload may also, or alternatively, include pictures and videos of the payload. The one or more sensors may communicate with the vehicle device via wired, wireless, and/or a combination of wired and wireless connections to provide signals (e.g., electrical, RF, optical, etc. signals) that include information associated with the payload.

The vehicle device may be a communication and computation device attached to, carried within and/or integrated into the material handling vehicle. The vehicle device may receive signals from the one or more sensors from which information associated with the payload may be obtained. The vehicle device may store and/or execute a material handling application to compute information associated with the payload (e.g., density, viscosity, flowability, cost, etc.), based upon signals received from the one or more sensors or information entered into the vehicle device by an operator (e.g., such as the driver of the material handling vehicle).

The vehicle device may communicate with one or more server devices, as hereinafter described, via a network, to send and/or receive information associated with the payload and/or information associated with a material handling project. Information associated with a material handling project may include, for example, the identification of the material handling vehicle (e.g. based on the vehicle identifier as hereinafter described), the location of the material handling vehicle, the route of travel of the material handling vehicle, the location of origin of a payload, the destination of a payload, the current speed of a material handling vehicle, the average speed of a material handling vehicle, the acceleration of a material handling vehicle, the direction of travel of a material handling vehicle, the number of trips required by the material handling vehicle to haul the requested payload, the date and/or time that a material handling vehicle arrived at a destination, the estimated date and/or time that a material handling vehicle will arrive at a destination, the fuel consumed by the material handling vehicle, identification of a project for which a payload is being hauled, scheduling of trips of material handling vehicles, the number of trips made by a material handling vehicle, etc. Information associated with a material handling project may also include environment information associated with a material handling project, such as current and/or forecasted weather conditions, traffic conditions, road conditions, etc. Information associated with a material handling project may also include identifying whether a material handling vehicle is available for hire, the schedule of a material handling vehicle, rate information (e.g. cost per mile, cost per ton, cost per trip, etc.) associated with a material handling vehicle, an amount of planned trips associated with a material handling project, a first location (e.g. name, address, operating hours, etc.) associated with a material handling project, a second location (e.g. name, address, operating hours, etc.) associated with a material handling project, a required time for arrival at a destination, a cost for a material handling project, an amount of payload to be hauled in a material handling project, etc.

The vehicle identifier may include one or more characters, such as alphanumeric characters, and/or symbols that uniquely identify a material handling vehicle. The vehicle identifier may be used to identify, track and/or authenticate the material handling vehicle. For example, the vehicle identifier may include a radio-frequency identification device, a matrix barcode, a Quick Response (“QR”) code, a standard bar code, a label, a string of alphanumeric characters, etc. The vehicle identifier may be stored within and/or located on another device, such as the vehicle device (e.g. identification contained in an application on the vehicle device, etc.) or a containment device (e.g. a plastic case, etc.). The vehicle identifier may be mounted on an external surface of the material handling vehicle. Additionally, or alternatively, the vehicle identifier may normally reside within the material handling vehicle, such as within the driver compartment, and may be produced by the driver of the material handling vehicle when the material handling vehicle is to be identified using the vehicle identifier. The vehicle identifier may identify the vehicle by visual inspection, such as when a person views the vehicle identifier. Additionally, or alternatively, the vehicle identifier may identify the material handling vehicle when the vehicle identifier is interrogated by a scanner device. The scanner device may be any sort of device capable of interrogating the vehicle identifier. For example, the scanner device may be a barcode reader, a radio-frequency identification device reader, etc. The scanner may be a vehicle device and/or a server device. The scanner may communicate with one or more server devices to transmit the information interrogated from the vehicle identifier to identify, authenticate and/or track the material handling vehicle. Additionally, or alternatively, the material handling vehicle may be identified using a geolocation technology based upon information received from one or more server devices.

Server devices may be a communication and/or computation device associated with anyone associated with material handling project. For example, server devices may be associated with a developer, a general contractor, a subcontractor, a warehouse, a fill yard, a source of a payload, a destination of a payload, or other person associated with a material handling project. The server device may communicate with the vehicle device and/or other server devices to send and/or receive information associated with a payload. Additionally, or alternatively, the server device may communicate with the vehicle device and/or other server devices to send and/or receive information associated with a material handling project. The server devices may store and/or execute a material handling application to compute information associated with the payload (e.g., density, viscosity, flowability, cost, etc.) and/or information associated with a material handling project (e.g. cost of the project, schedule of the project, location of the material handing vehicle based upon GPS coordinates, etc.) based upon signals received from vehicle device and/or other server devices and/or entered into the server device by an operator (e.g., cost per ton of a payload entered into the server device associated with a fill yard by someone associated with the fill yard). The material handling vehicle may send and/or receive information associated with a payload and/or information associated with a material handling project to and/or from a server device.

The systems and/or methods, as described herein, may provide a method for delivering one or more payloads to a second location from a first location via a material handling vehicle. The method for delivering a payload from a first location to a second location via a material handling vehicle may include a request from a server device associated with a requestor of a payload (e.g. a general contractor, a distributor, a builder, a manufacturing facility, etc.) for a payload to be delivered to a second location (i.e. the destination of the payload). The request may identify information associated with the second location (e.g. the name, address, hours of operation, etc.) as well as information associated with a material handling project (as further described herein). The server device may communicate, via the network, with a vehicle device associated with a material handling vehicle to ensure that the vehicle device receives the request from the server device. The material handling vehicle may accept the request to deliver the payload by accepting (e.g. executing a material handling application on the vehicle device, etc.) the request to deliver the payload. Thereafter, the material handling vehicle may travel to a first location where the payload is received. The first location may be associated with a server device. The server device associated with the first location may receive the request, via the server device associated with the requestor of the payload, for a payload to be delivered to a second location. In response, the server device associated with the first location may communicate, via the network, with the server device associated with the requestor and/or other server devices and vehicle devices to provide an amount of payload available at the first location, a price associated with the payload, and/or other information associated with the payload.

A sensor associated with the material handling vehicle may obtain information associated with the payload (as described herein). The sensor may communicate with the vehicle device (e.g. via a wired connection, a wireless connection, etc.) to provide the information associated with the payload to the vehicle device. The vehicle device may communicate, via the network, to provide the information associated with the payload received from the sensor to a server device. The vehicle device may additionally, or alternatively, communicate with a server device to send and/or receive information associated with a material handling project (as described herein). The material handling vehicle may deliver the payload to the second location.

The devices, vehicles, servers, networks and/or components thereof illustrated in FIGS. 1 through 4 are provided for explanatory purposes only, and the disclosure herein is not intended to be limited to the devices, vehicles, servers, networks and/or components provided therein.

FIG. 1 illustrates a diagram of an example environment in which the Systems and/or Methods described herein may be implemented. As shown in FIG. 1, Environment 100 may include a material handling vehicle 110 which may include a collection of devices, vehicles, servers networks and/or components, one or more sensors 120 (collectively referred to as “sensors 120” and individually, a “sensor 120”), a payload 130, a vehicle identifier 140, a vehicle device 150 (hereinafter “vehicle device 150”) and a vehicle 160. Environment 100 may also include a network 170 and one or more server devices 180-1 . . . 180-N (collectively referred to as “server devices 180” and individually a “server device 180”) (where N≧1). The devices, vehicles, servers, networks and/or components shown in FIG. 1 are provided for explanatory purposes only, and the disclosure herein is not intended to be limited to what is reflected in the drawings.

Sensor 120 may include any sort of device capable of obtaining information associated with a payload, including electro-optical sensors (in the infrared, ultra-violet and/or visual spectrum), cameras, video recorders, radio frequency (RF) sensors, ultrasonic sensors, laser sensors, thermocouples, proximity sensors, acoustic devices, chemical sensors, mechanical sensors, electro-mechanical sensors, potentiometers, geiger counters, gypsum resistance blocks, etc. Sensor 120 may be formed from a durable material (e.g. a metal alloy, composite, polymer, fiberglass, etc.) of sufficient strength and toughness to support the static and/or dynamic loads (e.g. forces, torques, tensions, compressions, stresses, strains, etc.) imparted on the one or more sensors 120 by the material handling vehicle 110, by the payload 130, and/or by any individuals associated with placing a payload 130 into a material handling vehicle 110, removing a payload 130 from a material handling vehicle 110, monitoring and/or adjusting a payload 130 contained within a material handling vehicle, etc. The types, shapes, quantities and placements of the one or more sensors 120 are not intended to be limited to what is shown in FIG. 1.

The one or more sensors 120 may communicate with vehicle device 150 to provide information associated with the payload 130. Information associated with the payload may include temperature, pressure, granularity, humidity, moisture content, weight, mass, density, volume, texture, pH, organic content (e.g. the amount of organic matter or biologic material in fill dirt, etc.), radioactivity, and any other information that may demonstrate a quality or characteristic of the payload. The information associated with the payload may also include pictures and/or videos of the payload. The one or more sensors 120 may communicate with the vehicle device 150 via wired, wireless, and/or a combination of wired and wireless connections (e.g. a wired network, a Bluetooth network, a local area network, etc.) to provide signals (e.g., electrical, RF, optical, etc. signals) that include information associated with the payload.

Payload 130 may include any type of material capable of being hauled by a material handling vehicle. For instance, payload 130 may include gravel, stone, sand, concrete, top soil, coal, grain, corn, construction materials, muck, fill dirt, gasoline, milk, palletized cargo, etc.

Vehicle identifier 140 may be used to identify, track and/or authenticate a material handling vehicle. Vehicle identifier 140 may include one or more characters, such as alphanumeric characters, and/or symbols that are unique to a specific material handling vehicle 110 and, therefore, can be used for identification purposes. For example, the vehicle identifier 140 may be a radio-frequency identification device, an identifier stored on a vehicle device 150, a matrix barcode, a Quick Response (“QR”) code, a standard bar code, a Global Trade Item Number (GTIN), a label, etc. The vehicle identifier 140 may be stored within another device, such as the vehicle device 150, or within a separate container (e.g. a plastic case, a metal case, etc.) that may protect the vehicle identifier 140. The vehicle identifier 140 may be mounted on an external surface of the material handling vehicle 110. Additionally, or alternatively, the vehicle identifier 140 may normally reside within the material handling vehicle 110, such as within the driver compartment, and may be produced by the driver of the material handling vehicle 110 when the material handling vehicle 110 is to be identified using the vehicle identifier 140. The vehicle identifier 140 may identify the vehicle by visual inspection, such as when a person views the vehicle identifier 140. Additionally, or alternatively, the vehicle identifier 140 may identify the material handling vehicle when the vehicle identifier 140 is interrogated by a scanner device. Vehicle identifier 140 may be formed from a material (e.g. a metal alloy, composite, polymer, fiberglass, etc.) of sufficient strength and toughness to support the static and/or dynamic loads (e.g. forces, torques, tensions, compressions, stresses, strains, etc.) imparted on the vehicle identifier 140 by the material handling vehicle 110 or by any person and/or device that interrogates vehicle identifier 140. The types, shapes and/or placement of vehicle identifier 140 are not intended to be limited to what is shown in FIG. 1. A material handling vehicle 110 may be identified by the vehicle identifier 140 to authorize a delivery of payload 130, to determine when a material handling vehicle 110 arrives at a location, to determine where to place a payload 130, etc. Additionally, or alternatively, vehicle identifier 140 may allow for confirmation of a vehicle device 150, ownership of the vehicle device 150, ownership of the material handling vehicle 110, etc.

Vehicle device 150 may include any computation and communication device that may communicate with one or more server devices 180, via a network 170, and/or may communicate with the one or more sensors 120. For example, vehicle device 150 may include a laptop computer, a personal computer, a personal digital assistant, a tablet computer, personal communications system (PCS) terminal (e.g., such as a smart phone that may include data processing and data communications capabilities), a personal gaming system, or another type of computation or communication device. Additionally, or alternatively, vehicle device 150 may include logic, such as one or more processing or storage devices, that can be used to perform processing activities on behalf of a user.

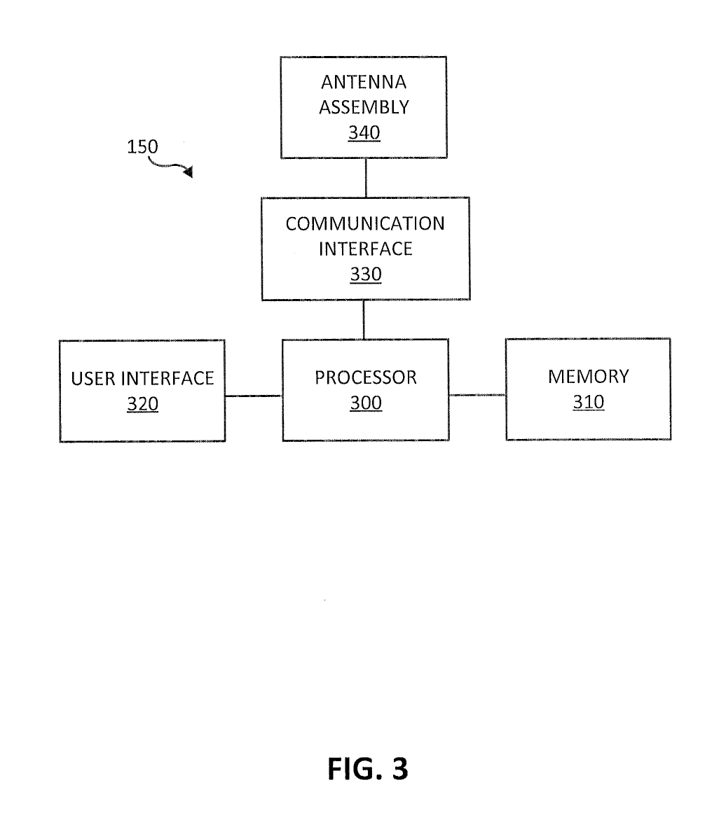

Vehicle device 150 may be configured to perform communication operations by sending data and/or receiving data from one or more sensors 120, vehicle identifier 140, another vehicle device, and/or server devices 180. Data may refer to any type of machine-readable information having substantially any format that may be adapted for use in one or more networks and/or with one or more components. Data may include digital information or analog information. Data may further be packetized and/or non-packetized. Vehicle device 150 may include logic for performing computations on vehicle device 150 and may include the components illustrated in FIG. 3 in an example implementation. Such components may execute one or more instructions, such as a material handling application, to perform functions as described herein. In one non-limiting implementation, the vehicle device 150 may not be in persistent communication and/or connection with network 170 but may, when accessed and/or communicated with, communicate, via network 170, with a server device 180, a scanner, one or more sensors 120 and/or another vehicle device 150. For example, vehicle device 150 may communicate with sensor 120 to receive information associated with a payload based upon executable instructions included in the vehicle device, such as based upon time, events (e.g. operating a cover associated with the material handling vehicle 110, operating another piece of equipment associated with the material handling vehicle 110, receiving a request for information from a server device, etc.), or other parameters identified in a material handling application.

Vehicle device 150 may store and/or execute a material handling application to enable the vehicle device 150 to communicate with the one or more sensors 120 to obtain and/or monitor information associated with the payload, as described herein, and/or to compute information associated with the payload (e.g., density, viscosity, flowability, etc.) based upon information received from the sensors 120 and/or server devices. For example, vehicle device 150 may execute a material handling application to determine that the material handling vehicle has arrived at a first location (e.g. using instructions to determine geolocation, etc). Additionally, or alternatively, a server device may execute the material handling application to determine that the material handling vehicle has arrived at the first location. The driver of the material handling vehicle 110 may also be able to enter, into the vehicle device 150, information associated with the payload (e.g., granularity, quality level, organic content, pictures etc.).

Vehicle device 150 may communicate with one or more server devices 180 via network 170 to send and/or receive information associated with the payload and/or information associated with a material handling project. Information associated with a material handling project may include, for example, the identification of the material handling vehicle (e.g. based on the vehicle identifier as hereinafter described), the location of the material handling vehicle, the route of travel of the material handling vehicle, the location of origin of a payload, the destination of a payload, the current speed of a material handling vehicle, the average speed of a material handling vehicle, the acceleration of a material handling vehicle, the direction of travel of a material handling vehicle, the number of trips required by the material handling vehicle to haul the requested payload, the date and/or time that a material handling vehicle arrived at a destination, the estimated date and/or time that a material handling vehicle will arrive at a destination, the fuel consumed by the material handling vehicle, identification of a project for which a payload is being hauled, scheduling of trips of material handling vehicles, the number of trips made by a material handling vehicle, etc. Information associated with a material handling project may also include environment information associated with a material handling project, such as current and/or forecasted weather conditions, traffic conditions, road conditions, etc. Information associated with a material handling project may also include identifying whether a material handling vehicle is available for hire, the schedule of a material handling vehicle, rate information (e.g. cost per mile, cost per ton, cost per trip, etc.) associated with a material handling vehicle, an amount of planned trips associated with a material handling project, a first location associated with a material handling project, a second location associated with a material handling project, a required time for arrival at a destination, a cost for a material handling project, an amount of payload to be hauled in a material handling project, etc.

Vehicle device 150 may also execute a material handling application to compare information associated with payload received from a server device 180 to information associated with payload received from the one or more sensors 120 and/or computed by the vehicle device 150 to determine whether the payload 130 is acceptable, how much to pay for a payload 130, where to place a payload 130, etc.

Vehicle device 150 may communicate with server device 180 (e.g. a server device associated with a developer, a general contractor, a subcontractor, a etc.) to receive instructions (e.g. request to hire, request to schedule a delivery, where to place a payload, parameters of a payload, etc.). Vehicle device 150 may also compute fees associated with a payload 130 (e.g., based on tonnage, volume, quantity of trips, duration of trips, travel time, a fixed rate (e.g., based on a contractual agreement), etc.). Vehicle device 150 may communicate with other vehicle devices 150 associated with other material handling vehicles 110 to compute fees based on payloads 130 hauled by the other material handling vehicles 110 associated with a material handling project. Vehicle device 150 may aggregate information obtained from other material handling vehicles 110 such as total payloads hauled, total payloads or tonnage rejected or accepted, picked up or deposited, total tonnage hauled, total mileage logged, total driver hours, total fuel consumed, rates of fuel consumption, etc. The vehicle device 150 may communicate aggregate information to other vehicle devices 150 and/or server devices 180 associated with a material handling project. Vehicle device 150 may be permanently installed in vehicle 160 and/or may be removable (e.g. removably installed, carried by a driver of the material handling vehicle, etc.) from the vehicle 160.

Vehicle 160 may include any means of transportation capable of hauling a payload 130. For example, vehicle may include a dump truck, cement mixing truck, flatbed truck, tractor trailer, a liquid tanker truck, low boy truck, a pickup truck, a car, and/or any other vehicle that may carry a payload.

Network 170 may include one or more wired and/or wireless networks. For example, network 170 may include a wide area network (WAN) a metropolitan network (MAN), a telephone network (e.g. the Public Switched Telephone (PSTN)), an ad hoc network, an intranet, the Internet, a fiber optic based network, and/or a combination of these or other types of networks. Additionally, or alternatively, network 170 may include a cellular network, a public land mobile network (PLMN), a second generation (2G) network, a third generation (3G) network, a fourth generation (4G) network (e.g., a long term evolution (LTE) network), a fifth generation (5G) network, and/or any other medium via which the server devices, vehicle devices, sensors and/or scanners may communicate.

Server device 180 may be any computation and communication device configured to gather, process, search, store, and/or provide information in a manner described herein. Server device 180 may be configured to communicate via network 170. Server device 180 may provide a user interface, website, and/or application that can be displayed, downloaded, and/or installed on vehicle device 150 and/or other server devices 180 to permit vehicle devices 150 and/or other server devices 180 to perform operations and/or display information as described herein. Server device 180 may be configured to communicate with network 170 and/or other server devices 180 and/or vehicle devices 150 via network 170 to perform operations such as, for example, those described herein and in the appendixes. Server device 180 may also, or alternatively, be configured to act as a web server or some other type of server that hosts one or more website and/or applications that may be accessed by vehicle devices 150 and/or another server device 180.

Server device 180 may be associated with one or more locations and/or others associated with a material handling project. For example, a server device 180 may be associated with a developer, a general contractor, a subcontractor, a warehouse, a fill yard, a payload source, a first destination, a second destination, or other person associated with a material handling project. Server device 180 may include logic, such as one or more processing or storage devices, that may be used to perform processing activities on behalf of a user. Server device 180 may execute an application to compute information associated with a payload and/or information associated with a material handling project. Additionally, or alternatively, server device 180 may transfer, via a network 170, instructions to the vehicle device 150 to be executed on the vehicle device 150. Additionally, or alternatively, vehicle device 150 may transfer, via network 170, instructions to the server device 180 to be executed on the server device 180.

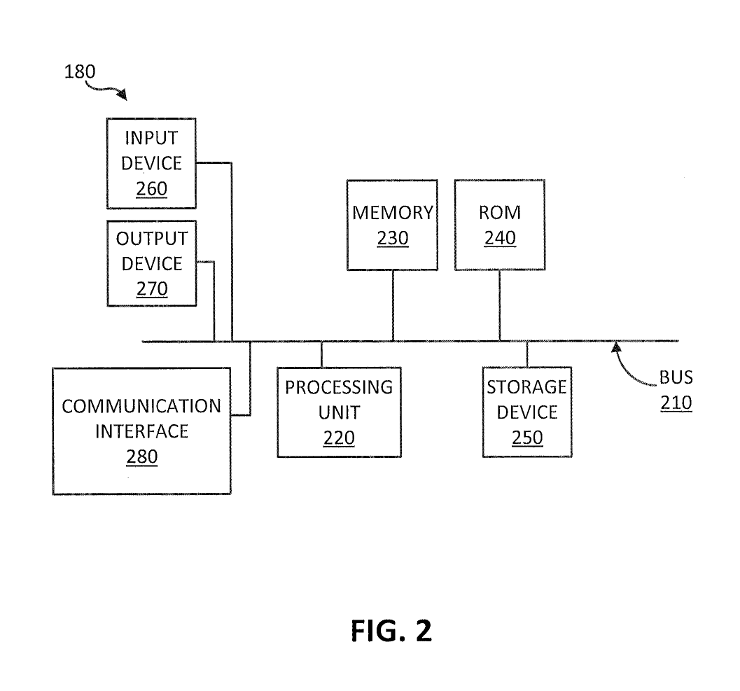

FIG. 2 illustrates a schematic view of a server device of FIG. 1. Server device 180 may include a collection of components, such as a bus 210, a processing unit 220, a memory 230, a read-only memory (“ROM”) 240, a storage device 250, an input device 260, an output device 270, and/or a communication interface 280. Bus 210 may include a path that permits communication among the components of server 220.

Although FIG. 2 depicts example components of server device 180, in other implementations, server device 180 may include fewer components, additional components, different components, or differently arranged components than illustrated in FIG. 2. For example, server device 180 may include a vehicle device 150. In still other implementations, one or more components of server device 180 may perform one or more tasks described as being performed by one or more other components of server device 180.

Processing unit 220 may include a processor, multiple processors, microprocessors, or other types of processing logic that may interpret, execute, and/or otherwise process information and/or data contained in, for example, the storage device 250 and/or memory 230. The information may include computer-executable instructions and/or data that may implement one or more embodiments of the Systems and/or Methods. Processing unit 220 may comprise a variety of hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. Processing unit 220 may comprise a single core or multiple cores. Moreover, processing unit 220 may comprise a system-on-chip (SoC) or system-in-package (SiP). Additionally, or alternatively, processing unit 220 (and/or another component of server 180) may be configured to generate and/or update keys (e.g., encryption keys, rotating keys, etc.).

Memory 230 may include a random access memory (RAM) or another type of dynamic storage device that may store information and instructions for execution by processing unit 220. ROM 240 may include a ROM device or another type of static storage device that may store static information and/or instructions for use by processing unit 220. Storage device 250 may include a magnetic and/or optical recording medium and its corresponding drive. In some implementations, memory 230 or storage device 250 may also be implemented as solid state memory, such as flash-based memory.

Input device 260 may include a mechanism that permits an operator to input information to server 210, such as a keyboard, a mouse, a pen, a single or multi-point touch interface, an accelerometer, a gyroscope, a microphone, voice recognition and/or biometric mechanisms, etc. Output device 270 may include a mechanism that outputs information to the operator, including a display, a printer, a speaker, etc. In the case of a display, the display may be a touch screen display that acts as both an input and an output device. Input device 260 and/or output device 270 may be haptic type devices, such as joysticks or other devices based on touch.

Communication interface 280 may include any transceiver-like mechanism that enables server device 180 to communicate with other devices and/or systems. For example, communication interface 280 may include mechanisms for communicating with another device or system via a network, e.g., a network interface card.

Server device 180 may perform certain operations in response to processing unit 220 executing software instructions contained in a computer-readable medium, such as main memory 230. For instance, server device 180 may implement an application by executing software instructions from main memory 230. A computer-readable medium may be defined as a non-transitory memory device, where the memory device may include a number of physically, possibly distributed, memory devices. The software instructions may be read into main memory 230 from another computer-readable medium, such as storage device 250, or from another device via communication interface 280. The software instructions contained in main memory 230 may cause processing unit 220 to perform processes described herein. Alternatively, hardwired circuitry may be used in place of, or in combination with, software instructions to implement processes described herein. Thus, implementations described herein are not limited to any specific combination of hardware circuitry and software.

FIG. 3 illustrates a schematic view of a vehicle device of FIG. 1. As shown in FIG. 3, vehicle device 150 may include a processor 300, a memory 310, a user interface 320, a communication interface 330, and/or an antenna assembly 340. Although FIG. 3 shows example components of vehicle device 150, in other implementations, vehicle device 150 may include fewer components, additional components, different components, or differently arranged components than depicted in FIG. 3. For example, vehicle device 150 may be a server device 180. In still other implementations, one or more components of vehicle device 150 may perform one or more tasks described as being performed by one or more other components of vehicle device 150.

Processor 300 may include a processor, a microprocessor, an ASIC, a FPGA, or the like. Processor 300 may control operation of vehicle device 150 and its components. In one implementation, processor 300 may control operation of components of vehicle device 150 in a manner similar to that described herein. Memory 310 may include a RAM, a ROM, and/or another type of memory to store data and/or instructions that may be used by processor 300.

User interface 320 may include mechanisms for inputting information to vehicle device 150 and/or for outputting information from vehicle device 150. Examples of input and output mechanisms might include buttons (e.g., control buttons, keys of keypad, a keyboard, a joystick, etc.); a touch screen interface to permit data and control commands to be input into vehicle device 150 via a display, a speaker to receive electrical signals and output audio signals; a microphone to receive audio signals and output electrical signals; a display to output visual information (e.g., photos of payload 130, web pages, etc.); a vibrator to cause vehicle device 150 to vibrate; and/or a camera and/or video camera to receive video and/or images.

Communication interface 330 may include a transceiver to perform functions of both a transmitter and a receiver of wireless communications, wired communications, or a combination of wireless and wired communications, including communications to/from server device 180, vehicle identifier 140, sensors 120, and/or another vehicle device 150.

Vehicle device 150 may perform certain operations described herein in response to processor 300 executing software instructions of an application contained in a computer-readable medium, such as memory 310. The software instructions may be read into memory 310 from another computer-readable medium or from another device via communication interface 330. The software instructions contained in memory 310 may cause processor 300 to perform processes described herein. Alternatively, hardwired circuitry may be used in place of or in combination with software instructions to implement processes described herein. Thus, implementations described herein are not limited to any specific combination of hardware circuitry and software.

Memory 310 may store information and instructions for execution by processor. Information and instructions may be read into memory 310 from another computer-readable medium, from another vehicle device and/or server device 180 via communication interface 330, and/or from user interface 320.

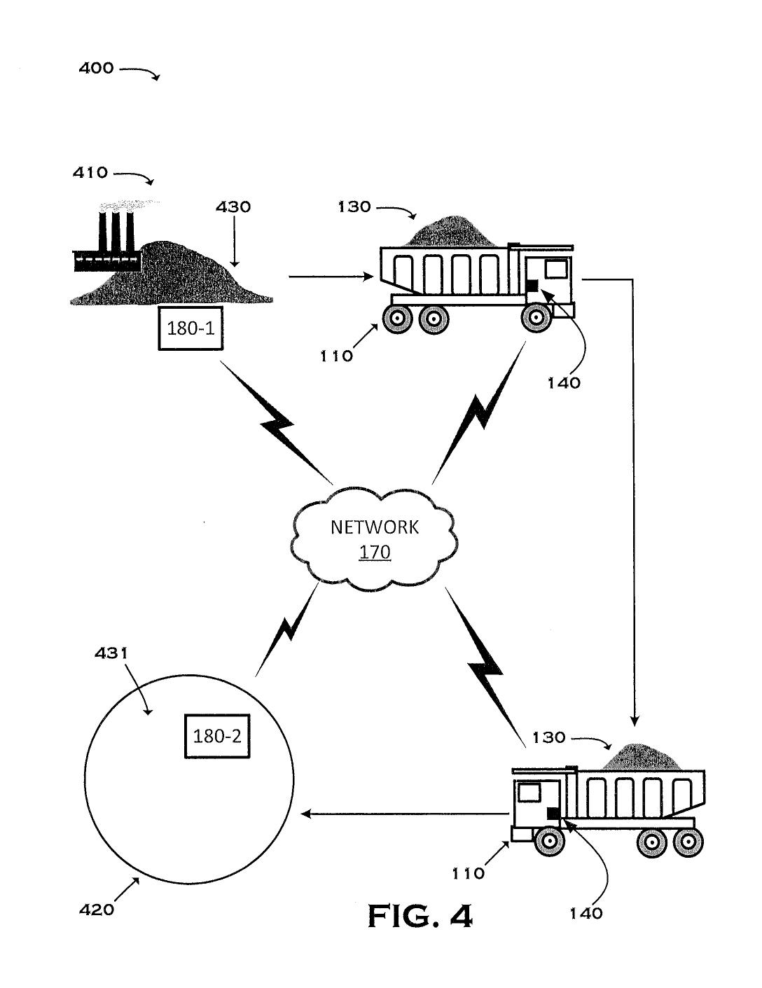

FIG. 4 is an example Environment 400 in which the Systems and/or Methods described herein may be implemented. As shown in FIG. 4, Environment 400 may include a first location 410, a second location 420, one or more material handling vehicles 110 and a network 170. The number of locations and material handling vehicles illustrated in FIG. 1 is provided for explanatory purposes only. The first location 410, second location 420 and material handling vehicles 110 may be interconnected by the network 170.

First location 410 may include any location or locations at which a material handling vehicle 110 may receive a payload 130. For example, first location may include a sand lot, a fill yard, a coal mine, a construction site, a cement factory, an oil refinery, a warehouse, grain solos, a refinery, etc. First location 410 may be associated with a first server device 180-1 through which it may communicate, via the network 170, with one or more server devices and/or vehicle devices associated with a material handling project, such as a server device associated with second location 420, material handling vehicle 110, and/or others associated with a material handling project (e.g. developers, general contractors, subcontractors, engineers, vehicle dispatchers, etc.). First location 410 may receive an instruction, via the network 170, from a server device 180 requesting payload 130 be delivered to material handling vehicle 110. The instruction may identify the material handling vehicle 110 to which the payload 130 should be delivered, the vehicle identifier 140 associated with the material handling vehicle 110, an estimated time of pick-up of the payload 130, and/or other information associated with the payload. The information associated with the payload may, for example, identify the type of payload 130 to be picked up (e.g., gravel, stone, top soil, coal, grain, etc.), an amount of the payload 130 to be delivered (e.g., in terms of volume, weight, density, etc.), a quality of the payload 130 (e.g., granularity, acceptable organic content, etc.), an acceptable temperature range of the payload 130, a moisture content range of the payload 130, any other acceptable value or range of values for the information associated with a payload, etc.

Upon receiving the instruction, the first location 410 may communicate, via the network 170, the existence of the payload 130, the price of the payload 130, and other parameters associated with the payload 130 (e.g. moisture content, viscosity, pictures, temperatures etc.) to the server device associated with the requestor of the payload and or a vehicle device, may request confirmation of the purchase of the payload 130 and/or prepare the payload 130 for pick-up and/or delivery by the material handling vehicle 110 at a designated time and/or place. First location 410 may communicate with the network 170 to track and/or determine when the material handling vehicle 110 has arrived at the first location 410 (e.g., based on a GPS signal, a terrestrial navigation system, interrogating the vehicle identifier 140, etc.) and/or a time at which the vehicle will likely arrive at the first location 410.

The first location 410 may be associated with a scanner 430 (e.g., a RFID scanner, QR code scanner, barcode scanner, a server device, etc.). Scanner 430 may be first server device 180-1 or another device. Scanner 430 may interrogate (e.g. scan the vehicle identifier using proximity readers, bar code readers, UPC scanners, communicating with the vehicle device to obtain the vehicle identifier located thereon, etc.) the vehicle identifier 140 of a material handling vehicle 110 to authenticate (i.e. confirm the identity of the material handling vehicle and confirm that it has arrived at first location 410) the material handling vehicle 100. Scanner 430 may communicate via network 170 with first server device 180-1 and/or other server devices to identify the presence of the material handling vehicle 110 at the first location and to confirm the identity of the material handling vehicle 110. Upon receiving signals from the scanner 430 identifying the material handling vehicle 110, the first server device 180-1 may authorize the material handling vehicle 110 to enter the first location 410, communicate with the first server device 180-1 (if scanner 430 is not first server device 180-1) and/or other server devices via the network 170 to confirm the presence and identity of the material handling vehicle 110 and/or authorize delivery of the payload 130 to the material handling vehicle 110.

Material handling vehicle 110 may communicate, via the network 170, with first location 410, second location 420, and/or others associated with a material handling project (e.g. developers, general contractors, subcontractors, engineers, vehicle dispatchers, etc.) to transmit and/or receive information associated with a payload and/or information associated with a material handling project. Material handling vehicle 110 may receive an instruction (e.g., from a server device associated with a general contractor, a truck dispatcher, and/or anyone else associated with a material handling project etc.) to haul a payload 130 from a first location 410 to a second location 420. The instruction may identify the first location 410 at which the payload 130 is to be picked up, a second location 420 to which the payload 130 is to be deposited, a time of pick-up and/or other information associated with a material handling project. The instruction may also identify information associated with the the payload 130. The information associated with a payload may, for example, identify the type of payload 130 to be picked up (e.g., gravel, stone, top soil, coal, grain, etc.), an amount of payload 130 (e.g., in terms of volume, weight, density, etc.), a quality of payload 130 (e.g., granularity, acceptable organic content, pressure, etc.), an acceptable temperature range of payload 130, a moisture content range of payload 130, etc. The instruction may identify a quantity of payloads 130 to be hauled, or total quantity of payload 130 to be hauled, a time period during which payload 130 may be picked up or deposited, etc. Upon receiving the instruction, the driver of the material handling vehicle 110 may cause the material handling vehicle 110 to proceed to the first location 410 to pick up the payload 130 at the designated time. Once the payload 130 is acquired from the first location 410, material handling vehicle 110 may communicate information associated with the payload (such as that obtained via sensors 120) to a server device associated with a material handling project.

Second location 420 may include any location or locations to which a material handling vehicle 110 may deliver a payload 130. For example, second location 420 may include a construction site, a landfill, a fill yard, a plant, a warehouse, a refinery, etc. Second location 420 may be associated with a second server device 180-2 through which second location 420 may communicate, via the network 170, with first location 410, material handling vehicle 110, and/or server devices 180 associated with others associated with a material handling project (e.g. developers, general contractors, subcontractors, engineers, vehicle dispatchers, etc.).

Second location 420 may communicate via the network 170 to obtain information associated with the payload 130 from the first location 410, the material handling vehicle 110, and/or others associated with a material handling project (e.g. developers, general contractors, subcontractors, engineers, vehicle dispatchers, etc.). Second server device 180-2 may compare the information associated with the payload received from the first location 410 to the information associated with the payload from the material handling vehicle 110 to determine whether to allow the payload 130 to be deposited at second location 420 and/or where the payload 130 is to be deposited at second location 420. Upon a favorable comparison, second location 420 may approve material handling vehicle 110 to deposit the payload 130. Upon an unfavorable comparison, second location 420 may require material handling vehicle 110 to deposit the payload 130 in an alternate location or to return the payload 130 to first location 410.

Second location 420 may be associated with a scanner 431 (e.g., a RFID scanner, QR code scanner, barcode scanner, a server device, etc.). Scanner 431 may function similarly to scanner 430 and may be second server device 180-2. Scanner 431 may interrogate the vehicle identifier 140 of a material handling vehicle 110 to authenticate the material handling vehicle 110. Scanner 431 may communicate via network 170 with second server device 180-2 and/or other server devices to identify the material handling vehicle 110, to confirm that material handling vehicle 110 is present at second location 420, to authorize material handling vehicle 110 to enter the second location 420, and/or to authorize receipt of the payload 130 from the material handling vehicle 110. Upon delivery of the payload 130, vehicle device may communicate information associated with a material handling project (e.g. cost information, schedule information, etc.) to a server device 180 associated with the individual requesting material handling services. The server device 180 may compute information associated with the material handling project, such as cost of the material handling services.

While preferred embodiments have been shown and described, those skilled in the art will recognize that other changes and modifications may be made to the foregoing embodiments without departing from the scope and spirit of the disclosure provided herein. For example, specific shapes of various elements of the illustrated embodiments may be altered to suit particular applications. It is intended to claim all such changes and modifications as fall within the scope of the disclosure herein and the equivalents.

The foregoing description provides illustration and description, but is not intended to be exhaustive or to limit the implementations to the precise form disclosed. Modifications and variations arc possible in light of the above disclosure or may be acquired from practice of the embodiments.

It will be apparent that the apparatus, devices, systems, methods, technologies and/or techniques as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms comprises and comprising, when used in this specification, are taken to specify the presence of stated features, integers, steps or components but do not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A material handling vehicle, configured to haul a payload from a first location to a second location, the material handling vehicle comprising:
a sensor to obtain information associated with the payload;
a vehicle device to:
communicate with the sensor to receive a signal that includes the information associated with the payload,
communicate with a server device, via a network, to send the information associated with the payload,
communicate with the server device, via the network, to send or receive information associated with a material handling project; and
a vehicle identifier to uniquely identify the material handling vehicle.

2. The material handling vehicle of claim 1, where the sensor is:
an electro-optical sensor,
a camera,
a video recorder,
a radio frequency (RF) sensor,
an ultrasonic sensor,
a thermocouple,
a laser,
a proximity sensor,
an acoustic sensor,
a chemical sensor,
a mechanical sensor,
an electro-mechanical sensor,
a potentiometer,
a geiger counter,
a pH sensor, or
a gypsum resistance block.

3. The material handling vehicle of claim 1, where the information associated with the payload is:
temperature,
presence,
pressure,
granularity,
humidity,
moisture content,
weight,
mass,
density,
volume,
pH,
organic content,
texture,
radioactivity,
video, or
a picture.

4. The material handling system of claim 1, where the information associated with the material handling project is:
a type of payload to be delivered,
an amount of payload to be delivered,
an acceptable value for the information associated with the payload,
an address of the first location,
an address of the second location,
a location of the material handling vehicle,
availability of the material handling vehicle,
identification of the material handling vehicle,
a route of travel associated with the material handling vehicle,
a speed of the material handling vehicle,
an average speed of the material handling vehicle,
a direction of travel of the material handling vehicle,
a number of trips associated with the material handling vehicle,
a date and time when the material handling vehicle arrived at the first location,
a date and time when the material handling vehicle arrived at the second location,
an estimated date and time when the material handling vehicle will arrive at the first location or the second location,
an amount of fuel being used by the material handling vehicle,
an amount of fuel that has been used by the material handling vehicle,
an identification of a project for which a payload is being hauled,
a schedule for the material handling vehicle,
weather conditions,
traffic conditions,
road conditions,
rate information associated with the material handling vehicle, or
cost information associated with a payload, a material handling vehicle or a material handling project.

5. The material handling vehicle of claim 1, where the vehicle device executes instructions to compute information associated with a material handling project.

6. The material handling vehicle of claim 1 where the vehicle device executes instructions to compute information associated with the payload using the signal obtained from the sensor.

7. The material handling vehicle of claim 1 where the vehicle device is permanently installed in the material handling vehicle.

8. The material handling vehicle of claim 1 where the vehicle device is removably installed in the material handling vehicle.

9. The material handling vehicle of claim 1 where the vehicle identifier is mounted to the vehicle.

10. The material handling vehicle of claim 1 where the vehicle identifier is located on the vehicle device.

11. The material handling vehicle of claim 1 where the vehicle device communicates with the sensor via a wired connection between the vehicle device and the sensor.

12. The material handling vehicle of claim 1 where the vehicle device communicates with the sensor via a wireless connection between the vehicle device and the sensor.

13. A material handling system, associated with the delivery of one or more payloads, the material handling system comprising:
a material handling vehicle configured to haul a payload from a first location to a second location, the material handling vehicle including:
a sensor to obtain information associated with a payload, of the one or more payloads,
a vehicle device configured to:
receive a signal from the sensor to obtain information associated with the payload, and
communicate with a first server device, via a network, to send the information associated with the payload and to send and/or receive information associated with a material handling project;
a vehicle identifier to uniquely identify the material handling vehicle;
the first server device configured to communicate with the vehicle device to send and/or receive information associated with a material handling project and to receive information associated with the payload.

14. The material handling system of claim 13 further including a scanner configured to interrogate the vehicle identifier to authenticate the material handling vehicle.

15. The material handling system of claim 14 where the scanner is a server device.

16. The material handling system of claim 13 further including a second server device configured to send information associated with a material handling project to the first server device or to receive information associated with a material handling project from the first server device.

17. The material handling system of claim 13 where the first server device is associated with the first location, the second location, or a requestor of the payload.

18. A method for delivering a payload from a first location to a second location via a material handling vehicle, the method comprising:
receiving, by a vehicle device and from a server device, a request via a network for a payload to be delivered to a second location, the vehicle device being associated with a material handling vehicle;
accepting, by a vehicle device via the network, the request from the server device;
obtaining, by the material handling vehicle, the payload from the :first location;
obtaining, by a sensor associated with the material handling vehicle, information associated with the payload;
providing, by the sensor via a wired or wireless connection, to the vehicle device the information associated with the payload;
providing, by the vehicle device via the network, to the server device the information associated with the payload;
delivering, by the material handling vehicle, the payload to the second location; and
providing, by the vehicle device via the network, to the service device confirmation that the payload has been delivered to the second location.

19. The method of claim 18, further comprising:
scanning, by a scanner associated with the first location or the second location, a vehicle identifier associated with the material handling vehicle; and
providing, by a second server device associated with the scanner, the identification of the material handling vehicle to the first server device.

20. The method of claim 19 where the scanner is the second server device or the vehicle identifier is located on the vehicle device.
